(19) United States
(12) Patent Application Publication
(10) Pub. No.: US 2011/0202572 A1
(43) Pub. Date: Aug. 18, 2011

(54) SYSTEMS AND METHODS FOR INDEPENDENTLY MANAGING CLINICAL DOCUMENTS AND PATIENT MANIFESTS AT A DATACENTER

(76) Inventors: Kinson Kin Sang Ho, Waterloo (CA); Ronald Friedrich Pfeifle, Waterloo (CA)

(21) Appl. No.: 12/705,133

(22) Filed: Feb. 12, 2010

(51) Int. Cl. G06F 17/30

(52) U.S. Cl. 707/802; 707/E17.005

(57) ABSTRACT

A system and method for managing clinical documents and patient manifests at a datacenter comprising providing a processor and a memory operatively coupled thereto, receiving at least one update message at the processor, the at least one update message comprising at least one of: at least one new clinical document to be added to the memory, and instructions to delete at least one existing clinical document from the memory, updating the memory in accordance with the update message, determining whether to generate at least one new patient manifest based on predetermined criteria, the at least one patient manifest being indicative of the update performed, and generating the at least one patient manifest wherein when the processor determines that the at least one patient manifest should be generated.

### FIELD

The invention relates generally to the field of data storage systems and particularly to the field of data storage systems within the medical industry.

### BACKGROUND

The field of medical information systems has been expanding field for several decades. With increasing diagnostic tools, increasing population, widespread access to medical treatment, and the desirability of sharing information between doctors and professionals, the field medical information systems is likely to continue growing. To address this continued growth, and the subsequent inconveniences of paper and other fixed forms of clinical documents storage, the medical community has increasingly turned to digital forms of clinical document management.

Increase in use of digital forms of clinical document manage has led to an increase in the number of datacenters storing clinical documents. Such datacenters are now wide spread among various entities in the industry from a private physician's office to a clinic to an acute care in-patient facility or an insurance provider. While there is sharing of clinical documents between datacenters, the datacenters tend to be independent and self included in that no information other than the copies of the clinical documents are shared between the datacenters. That is, the internal state and administration of each datacenter is conducted without knowledge of activities occurring in other datacenters.

To manage clinical documents stored in a datacenter, the datacenter may use various industry standards. One such standard is Cross-Enterprise Document Sharing (XDS) defined by Integrating the Health Care Enterprise (IHE). A datacenter in accordance with the XDS standard will inform a document registry of the contents stored in the datacenter to facilitate searching for the contents of the datacenter at the document registry. The document registry may be updated by a plurality of datacenters connected to it. However, in circumstances where a plurality datacenters are updating a common document registry, it may lead to generation of redundant data, which may lead to deterioration in performance of the document registry.

Accordingly, there is a need for improved document coordination in datacenters that addresses at least one of the shortcomings in existing datacenters.

### SUMMARY

According to one embodiment, there is provided a computer implemented method for managing clinical documents and patient manifests at a datacenter comprising:

a) providing a processor and a memory operatively coupled thereto;

b) receiving at least one update message at the processor, the at least one update message including at least one of: at least one new clinical document to be added to the memory, and instructions to delete at least one existing clinical document from the memory;

c) updating the memory in accordance with the update message;

d) determining whether to generate at least one new patient manifest based on predetermined criteria, the at least one patient manifest being indicative of the update performed; and e) generating the at least one patient manifest wherein when the processor determines that the at least one patient manifest should be generated.

In some embodiments, when the at least one update message comprises the at least one new clinical document, the predetermined criteria comprises at least one of information about the source of the at least one update message, and whether the new clinical document to be added has associated with it at least one existing manifest, and whether the datacenter has previously generated the at least one existing manifest for that document.

In some embodiments, the at least one new patient manifest is not generated when at least one of the following predetermined criteria is met: the at least one new patient manifest is not generated when at least one of the following predetermined criteria is met: the at least one new clinical document is associated with the at least one existing manifest, and the at least one new clinical document is received from another datacenter; and the at least one new clinical document is not associated with the at least one existing manifest, and the datacenter is not a datacenter that has previously generated the at least one existing manifest for that document.

In some embodiments, the at least one patient manifest is generated when at least one of the following predetermined criteria is met: the at least one new clinical document is associated with the at least one existing manifest and the datacenter is a datacenter that has previously generated the at least one existing manifest for that document; and the at least one new clinical document is not associated with an existing manifest, and the clinical document is received from a source system.

In some embodiments, the at least one update message comprises instructions to delete the at least one existing clinical document, the predetermined criteria comprises whether that datacenter has previously generated the at least one existing manifest for the at least one existing clinical document.

In some embodiments, the at least one patient manifest is generated when the datacenter has previously generated the at least one existing manifest for the at least one existing clinical document.

In some embodiments, the method further comprises transmitting the at least one update message to at least one other datacenter.

In some embodiments, when the at least one datacenter fails before transmitting the at least one update message, the at least one source system detects the failure at that datacenter, and sends that update message to at least one other datacenter, and the processor in that datacenter and the datacenter that failed manages at least one manifest associated with the at least one update message independently.

In some embodiments, the format of the at least one patient manifest is compatible with cross-platform document sharing (XDS) standard.

According to yet another embodiment, there is provided a system for managing clinical documents and patient manifests at a datacenter comprising:

a) at least one datacenter having a processor and a memory operatively coupled thereto; and

b) at least one source system in data communication with the at least one datacenter, the source system configured to generate at least one update message comprising at least one new clinical document to be added to the memory of that datacenter, or instructions to delete at least one existing clinical document from the memory of that datacenter, and sending the at least one update message to that datacenter;

wherein the processor in each datacenter is programmed for:
i) receiving the at least one update message;
ii) updating the memory of that datacenter in accordance with the update message;
iii) determining whether to generate at least one new patient manifest based on predetermined criteria, the at least one patient manifest indicative of the update performed;
iv) generating the at least one patient manifest wherein when the processor determines that the new patient manifest should be generated.

According to some embodiments, when the at least one update message comprises the at least one new clinical document, the predetermined criteria comprises at least one of information about the source of the at least one update message, and whether the new clinical document to be added is associated with at least one existing manifest, and whether the datacenter has previously generated the at least one existing manifest for that document.

According to some embodiments, the processor in the at least one datacenter is further programmed not to generate the new patient manifest when at least one of the following predetermined criteria is met: the at least one new clinical document is associated with the at least one existing manifest, and the at least one new clinical document is received from another datacenter; and the at least one new clinical document is not associated with the at least one existing manifest, and the datacenter is not a datacenter that has previously generated the at least one existing manifest for that document.

According to some embodiments, the processor in the at least one datacenter is further programmed to generate the new patient manifest at least one of the following predetermined criteria is met: the at least one new clinical document is associated with the at least one existing manifest and the datacenter is a datacenter that has previously generated the at least one existing manifest for that document; and the at least one new clinical document is not associated with an existing manifest, and the clinical document is received from a source system.

According to some embodiments, the at least one update message comprises instructions to delete the at least one existing clinical document, the predetermined criteria comprises whether that datacenter has previously generated at least one previous patient manifest for the at least one existing clinical document.

According to some embodiments, the new patient manifest is generated when that datacenter has previously generated the at least one existing manifest for the at least one existing clinical document.

According to some embodiments, the format of the at least one patient manifest is compatible with cross-platform document sharing (XDS) standard.

According to some embodiments, the processor is further programmed for transmitting at least one update message to at least one other datacenter.

According to some embodiments, when the at least one datacenter fails before transmitting the at least one update message, the at least one source system is further configured to detect the failure at that datacenter, and send that update message to at least one other datacenter, and the processor in that datacenter and the datacenter that failed is further programmed to manage at least one manifest associated with the at least one update message independently.

According to yet another embodiment, there is provided a datacenter comprising a memory and a processor operatively coupled to the memory wherein the processor is programmed for:

a) receiving at least one update message at the processor, the at least one update message comprising at least one of: at least one new clinical document to be added to the memory, and instructions to delete at least one existing clinical document from the memory;

b) updating the memory in accordance with the update message;

c) determining whether to generate at least one new patient manifest based on predetermined criteria, the at least one patient manifest being indicative of the update performed; and

d) generating the at least one patient manifest wherein when the processor determines that the at least one patient manifest should be generated.

In some embodiments, when the at least one update message comprises the at least one new clinical document, the predetermined criteria comprises at least one of information about the source of the at least one update message, and whether the new clinical document to be added has associated with it at least one existing manifest, and whether the datacenter has previously generated the at least one existing manifest for that document.

In some embodiments, the at least one new patient manifest is not generated when at least one of the following predetermined criteria is met: the at least one new patient manifest is not generated when at least one of the following predetermined criteria is met: the at least one new clinical document is associated with the at least one existing manifest, and the at least one new clinical document is received from another datacenter; and the at least one new clinical document is not associated with the at least one existing manifest, and the datacenter is not a datacenter that has previously generated the at least one existing manifest for that document.

In some embodiments, the at least one patient manifest is generated when at least one of the following predetermined criteria is met: the at least one new clinical document is associated with the at least one existing manifest and the datacenter is a datacenter that has previously generated the at least one existing manifest for that document; and the at least one new clinical document is not associated with an existing manifest, and the clinical document is received from a source system.

In some embodiments, the at least one update message comprises instructions to delete the at least one existing clinical document, the predetermined criteria comprises whether that datacenter has previously generated the at least one existing manifest for the at least one existing clinical document.

In some embodiments, the at least one patient manifest is generated when the datacenter has previously generated the at least one existing manifest for the at least one existing clinical document.

In some embodiments, the method further comprises transmitting the at least one update message to at least one other datacenter.

In some embodiments, when the at least one datacenter fails before transmitting the at least one update message, the at least one source system detects the failure at that datacenter, and sends that update message to at least one other datacenter, and the processor in that datacenter and the datacenter that failed manages at least one manifest associated with the at least one update message independently.

### DRAWINGS

For a better understanding of the embodiments described herein and to show more clearly how they may be carried into effect, reference will now be made, by way of example only, to the accompanying drawings which show at least one example embodiment, and in which:

FIG. 1 is schematic representation of a system for managing clinical documents and patient manifests according to the embodiments described herein;

FIG. 2 is a schematic representation of contents of an exemplary patient manifest;

FIG. 3 is a flowchart illustrating the steps of a computer-implemented method for managing patient manifests and clinical documents at a datacenter according the embodiments described herein;

FIG. 4 is a flowchart illustrating the steps of a computer-implemented method for determining whether a patient manifest should be generated when a clinical document is added to the memory of the datacenter according to the embodiments described herein;

FIG. 5 is a flowchart illustrating the steps of a computer-implemented method to determine whether a patient manifest should be generated when a clinical document is deleted from the memory of the datacenter according to the embodiments described herein; and

FIG. 6 is a flowchart illustrating the steps of a computer-implemented method 130 for managing patient manifest in an exemplary data management system during a datacenter failover according to the embodiments described herein.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, or cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

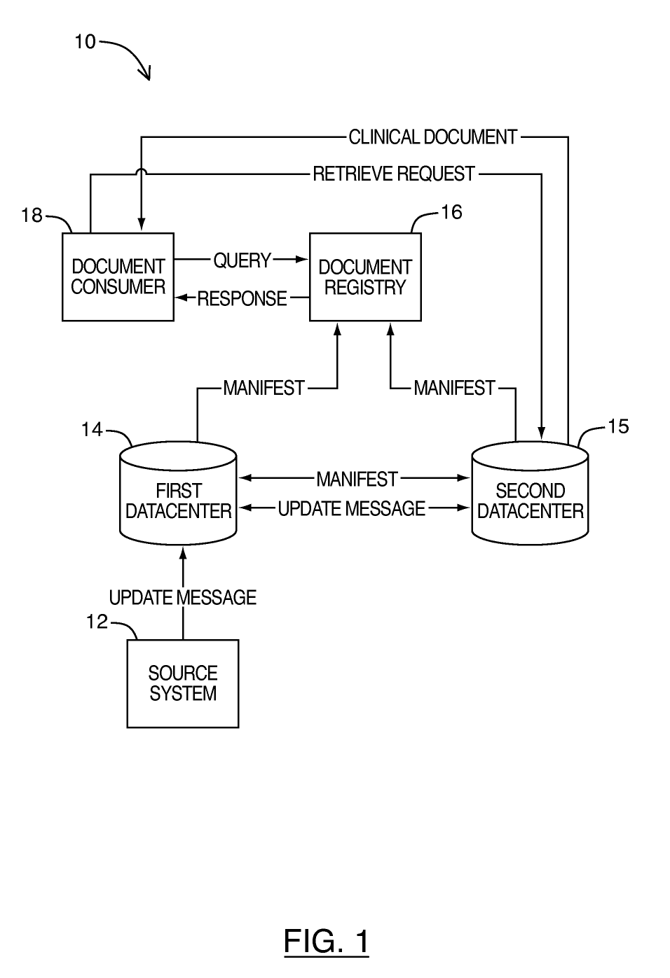

Referring now to FIG. 1, illustrated therein is a system 10 for managing clinical documents and patient manifests according to one embodiment of the invention. The system 10 comprises a source system 12, a first datacenter 14, a second datacenter 15, a document registry 16 and a document consumer 18. The system 10 is described herein to include a certain number of components, namely one source system, two datacenters, one document registry and one document consumer. However, the number of these components included within a system might differ in other embodiments. For example, there could be more than two datacenters and more than one source system which may be connected to any, some or all of the datacenters. Similarly, there could also be more than one document consumer and document registry.

The system 10 is implemented to comply with specifications laid out by Cross-Enterprise Document Sharing (XDS) defined by Integrating the Health Care Enterprise (IHE).

The source system 12 generates at least one update message to be transmitted to the first datacenter 14. The update message comprises at least one of instructions to add at least one new clinical document to the first datacenter 14 or instructions to delete at least one existing clinical document from the first datacenter 14. The update message comprising instructions to add the at least one new clinical document may also comprise the at least one clinical document and/or metadata for that clinical document. Update message comprising of instructions to delete at least one existing clinical document may comprise information required to uniquely identify and locate that existing clinical document in the datacenter.

The source system 12 may be a combination of hardware and software components. The source system 12 may be an acquisition source (i.e. modality), generating one or more clinical documents. For example, the source system 12 may be medical imaging instruments such as an X-ray, ultrasound, magnetic resonance, positron emission tomography, computed tomography, endoscopy, mammograms, digital radiography, and cardiology machines. The source system 12 may be other software systems such as a picture archiving and communication systems (PACS). The source system 12 may also include human actors. For example, an ultrasound system will generally include a hardware component, a software component and a medical professional to operate the system.

The clinical document includes information pertaining to an individual patient, and it may be image data or non-image data. The information included in the clinical document could be medical and/or non-medical in nature. For example, the information included in a clinical document may be medical in nature such as an X-Ray image of a patient's wrist or a doctor's diagnosis of the patient. The information may also be non-medical in nature such as biographical information, contact information or emergency contact information.

The clinical document may be generated in a clinic, hospital, or other entities contributing to an individual's health and well-being. For example, the clinical document generated by an insurance company may include insurance information such as the name of the insurer and the insurance policy number. Generally, the clinical document includes information about an individual that a health provider may wish to consider.

The clinical document may be formatted to work with various software. For example, the clinical document may be formatted to comply with Adobe published document format (PDF). In another example, the clinical document may be an image formatted to comply with Digital Imaging and Communications in Medicine (DICOM) standard. In another example, the clinical document may be in a Health Level 7 Clinical Document Architecture (HL7 CDA) format that is used to define clinical information such as medical summary, diagnostic report, discharge summary and, lab report. The clinical document may also be converted from one format to another prior to transmittal and/or storage. For example, an image document in JPEG format might be converted into PDF format prior to transmittal and/or storage.

While clinical documents maybe of varying formats, XDS systems generally only store PDF format documents, text documents, or patient manifests. Clinical documents that are not PDF, text or manifests may be converted to one of these formats.

The clinical document may also be compressed prior to transmittal and/or storage to reduce the size of the document. Compressing algorithms that may be used to compress clinical documents may include lossy or lossless variants of the JPEG format for images, as well as a lossless Run-Length Encoding format, which is similar to the packed-bits of compression found in some TIFF format images. Other compression algorithms may also be used. The source system 12 may also generate metadata along with the clinical document.

Metadata includes information about the clinical document. For example, metadata may include biographical information about the subject patient and/or the clinical document. For example, metadata may include information such as the patient's name, age, and gender. The metadata may also include information such as the type of scanner, information about the patient that the clinical document represents (e.g. X-Ray of right wrist, blood test results for chemical “x”), information about the attending physician, image dimensions, and/or the type of hardware and/or software used to generate the clinical document. The metadata may also include references the clinical documents. For example, metadata may include a hyperlink to reference the image as a DICOM Web Access of DICOM Objects (WADO) URI or as IHE Retrieve Information for Display (RID) request for document.

The metadata may be sent along with the clinical document in a single file. For example, a single DICOM file includes both the metadata as well as all of the image data. The metadata may also be sent in a separate file from the document. For example, Analyze format stores the image data in one file, ending with the extension “.img” and the metadata in another file, ending with the extension “.hdr”.

The source system 12 is in data communication with the first datacenter 14. The data communication may be facilitated locally through a Local Area Network (LAN). The data communication may also be facilitated through a Wide Area Network such as the Internet. In other examples, the communication may be facilitated through a combination of one or more local area and wide area networks. Communications between the source system 12 and first datacenter 14 may be encrypted or otherwise secured to address security concerns.

The first datacenter 14 is a document repository responsible for persistent storage of clinical documents and generated manifests. The first datacenter 14 has a processor and a memory operatively coupled to the memory. The memory is used at least for storing clinical documents and patient manifests.

The first datacenter 14 may also have back-up systems for disaster recovery purposes. For example, the first datacenter 14 may have memory organized in Redundant Array of Independent Disks (RAID) standard to promote data resiliency. Periodical backups of the memory in the first datacenter 14 may be performed and the back up copy may be stored at a different geographical location from that of the first datacenter 14.

For storing large volumes of clinical documents, the first datacenter 14 may utilize database software to organize and store the clinical documents in the memory. The database software may organize the clinical documents according to various database architectures. For example, the clinical documents may be stored as a relational database in the datacenter. However, the first datacenter 14 need not use database software. For example, the first datacenter 14 may store the clinical documents in the memory without using any database software.

To facilitate efficient retrieval of clinical documents stored in the first datacenter 14, the first datacenter 14 may assign a pointer to each document. For example, the pointer may be a uniform resource identifier (URI). The pointer of a clinical document includes information indicative of the location of the clinical document within the memory of the first datacenter 14.

The first datacenter 14 receives the at least one update message from the source system 12 comprising at least one of the at least one new clinical document to be added and instructions to delete the at least one existing clinical. The first datacenter 14 will update its memory in accordance with the update message. That is, if the update message comprises instructions to delete the at least one existing clinical document in the memory, the first datacenter 14 will delete that clinical document from its memory. If the update message comprises the at least one clinical document to be added, the first datacenter 14 will store that clinical document in its memory.

In this embodiment, in accordance with the XDS standards, only the source system 12 may send the update message comprising instructions to delete a clinical document. However, in other embodiments, the update message including instructions to delete a clinical document may also be received from the document consumer 18. In yet another embodiment, the first datacenter 14 may also periodically delete clinical documents stored in its memory on its own initiative.

The first datacenter 14 may be in communication with the second datacenter 15. Each update message received at the first datacenter 14 may be forwarded to the second datacenter 15 such that the second datacenter 15 may also perform similar update to the clinical documents stored in its memory. By forwarding each update message to second datacenter 15, each datacenter is self-contained and the system encourages resiliency through data redundancy.

The second datacenter 15 may comprise a processor and a memory operatively coupled thereto. The memory may be used at least for storing clinical documents and patient manifests received at the datacenter. The second datacenter may receive forwarded update messages from the first datacenter and/or a source system.

The recipient second datacenter 15 to determine the source of the update message, for example, by analyzing the network address of the sender.

That is, the recipient datacenter may be configured to consider update messages received from certain network addresses associated with other datacenters as replica. In another embodiment, the update message may also be marked as “replica” by a datacenter that is forwarding the update message to another datacenter to assist in determination of the source of the update message.

The first datacenter 14 and the second datacenter 15 are collectively responsible for informing the document registry 16 of the changes to the clinical documents each of them are storing. By keeping the information in the document registry 16 reflective of the contents of all of the datacenters connected to the document registry, the document consumer 18 can use the document registry 16 as the primary search venue to attempt to locate clinical documents located in all of the datacenters connected to the document registry 16.

To inform the document registry 16, either the processor in first datacenter 14 or the second datacenter 15 will generate at least one patient manifest to reflect changes being performed on their memory. As described below, generally only one of the datacenters 14 and will generate a patient manifest reflective of a change to reduce the possibility of redundant patient manifests in the document registry 16. The patient manifest generated is reflective of the change in that datacenter. For example, if the change performed was adding a clinical document to the datacenter, the patient manifest including information about that document being added may be generated. In another example, if the change performed was deleting a clinical document from the datacenter, the patient manifest stating that the clinical document has been deleted from the datacenter may be generated.

The patient manifest may include information about clinical documents associated with a patient. For example, a patient manifest may include some or all of the metadata about the clinical document received from the source system 12. The patient manifest may also additional information generated by the first datacenter 14 or the second datacenter 15. The patient manifest may also include a unique manifest number to identify the patient manifest. The patient manifest may include a list of clinical documents associated with the patient, and information relating to the location of those clinical documents. The manifest may also include author information and information about the clinical context and information about a clinical document and relationships to other clinical documents.

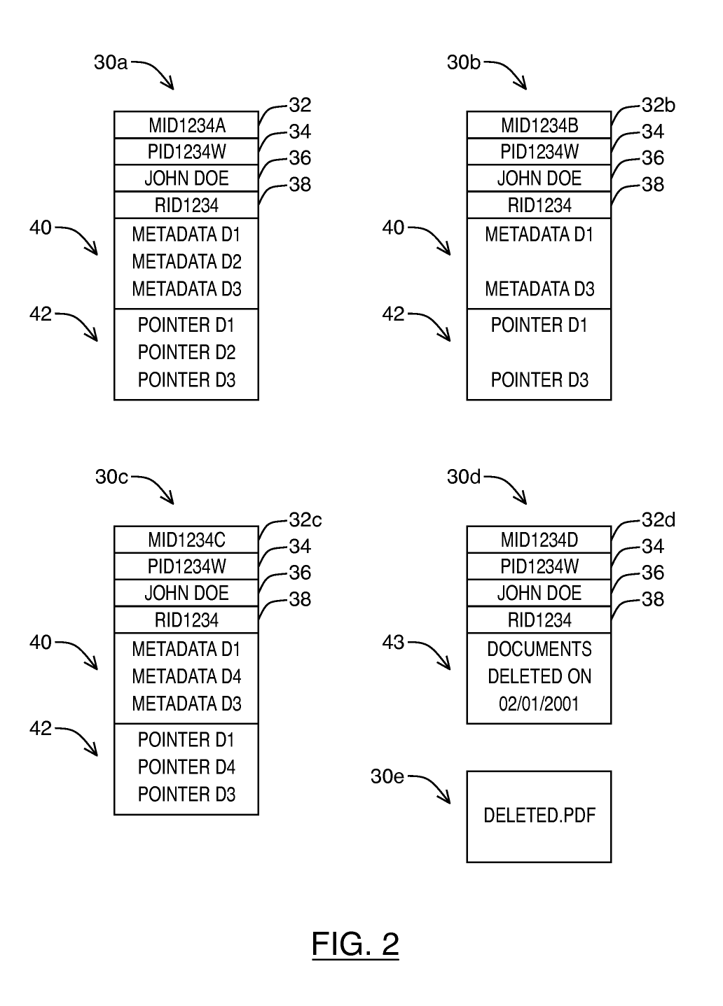

Referring now to FIG. 2, illustrated therein is the contents of an exemplary patient manifest 30a. Patient manifest 30a includes a manifest identifier 32 comprising an universally unique identifier (UUID), a patient identifier 34 for an affinity domain, a patient name 36, a repository unique identifier 38, and a list 40 of clinical documents and corresponding one or more pointers 42 relating to that list. The list of clinical documents comprises metadata about the clinical documents, but not the clinical documents themselves. The pointers 42 include information to identify a location whereby a clinical document corresponding to the pointer may be retrieved. For example, pointer D1 includes information about where clinical document D1 may be retrieved, pointer D2 for clinical document 2, and pointer D3 for clinical document 3. The manifest identifier 32 is unique to the system 10. A system-wide unique number can be generated by incorporating a time variable and ensure that the clock between the components of the system are synchronized. Aside from a time variable, there might also be other components that guarantee that the UUID is globally unique as will be evident to one skilled in the art.

Patient manifest 30b is another exemplary patient manifest generated after clinical document 2 has been deleted. The contents of patient manifest 30b are similar to patient manifest 30a and like elements are indicated by like reference numerals. A new manifest identifier 32b has been assigned to the patient manifest 30b. Metadata for clinical document 2 and the pointer to the clinical document 2 has been removed from the patient manifest.

Patient manifest 30c is another exemplary patient manifest generated after a new clinical document 4 has been added to the datacenter. The contents of patient manifest 30c are similar to patient manifest 30a and like elements are indicated by like reference numerals. Once again a new unique manifest identifier 32c has been assigned to the patient manifest 30c. Metadata for document 4 and the pointer for clinical document 4 is now included in the patient manifest 30c.

Patient manifest 30d is another exemplary patient manifest generated after all clinical documents associated with the patient have been deleted. The contents of patient manifest 30d are similar to patient manifest 30a and like elements are indicated by like reference numerals. Patient manifest 30d does not include any documents or pointers. Patient manifest 30d includes an entry 42 stating that documents had been deleted at a prior time to indicate that the patient manifest 30d is acting as placeholder for a patient manifest that had been deleted. In some embodiments, a placeholder such as a text file or a PDF file indicating that that all documents associated with a patient had been deleted may be used instead of a patient manifest. For example, a PDF file 30e entitled “Deleted.PDF” including a statement indicating that all associated documents had been deleted may be used to indicate that all clinical documents associated with a patient has been deleted.

Patient manifests 30a-30d comprise changes to the clinical documents associated with the patient. These changes may be communicated to the document registry 16 in various ways. In one example, the generated manifest is simply submitted to the document registry 16 without specifying the currency of the manifest. The document registry will treat this manifest and the previously submitted manifests (if any) as equally valid. In another example, each patient manifest 30a-30d may be submitted to the document registry 16 using a XDS-defined relationship “REPLACE”. This indicates that the patient manifest being submitted is intended to replace a previous version of the manifest. The document registry 16 will deprecate the previous version of the manifest accordingly. In yet another example, a XDS-defined relationship “APPEND” may be used to communicate the changes to the document registry 16. Using the APPEND relationship, the generated manifest only contains the changes currently made to the clinical documents. The generated manifest comprising only the changes is submitted to the document registry 16. The submitted manifest and previous version(s) of the manifest are linked together by the document registry 16 to provide a full picture of the documents in the document registry.

Document registry 16 receives metadata including information about the clinical documents stored in the datacenters that are providing the metadata to the document registry 16. In the embodiment as shown, the metadata is provided in the form of patient manifests. In the embodiment as shown, in accordance with the XDS standard, the clinical documents are not provided to the document registry, and only the meta data about the clinical documents in form of patient manifests are provided. However, in another embodiments, some clinical documents may be provided to the document registry. For example, document registry 16 may wish to store frequently requested clinical documents for caching purposes.

The document registry 16 may organize and store received patient manifests using a database software. Since the document registry 16 acts as the primary search venue for document consumers 18, the document registry 16 may organize received patient manifests to optimize searching performance.

The document registry 16 may respond to queries from the document consumer 18. Queries may be for various clinical documents that may be stored in the datacenters connected to the document registry 16. The document registry may also support various Boolean syntax to facilitate various queries. A response to a query may contain the metadata information associated with a clinical document. In this embodiment, since the clinical documents themselves are not stored in the document registry 16, it may not provide the clinical documents directly to the document consumer 18. However, the metadata associated with the clinical document will generally contain information as to the location of the clinical document such that it may be retrieved from that location.

The document consumer 18 may be any entity that may wish to search for and retrieve a clinical document. For example, a document consumer 18 may be a health care professional working at an in-patient facility. In another example, a document consumer 18 may be a specialist working at an out-patient facility. In another example, a document consumer 18 may be a long-term care facility. The document consumer 18 may also be a non-human entity. For example, a document consumer 18 may be a clinical IT software that wishes to retrieve a clinical document for its own records. In another example, a document consumer 18 may be a proxy software program that interfaces with the document registry 16 and the datacenter on behalf of a client that cannot interface with the document registry 16 directly. Further examples of consumer 18 include but are not limited to, personal computers, laptop computers, slim line computers, server based computers, handheld computers, and any other such device that is able to provide an interface and connect to the document registry 16.

The document consumer 18 may submit at least one query to the document registry. The query may relate to clinical documents stored in the datacenters connected to the document registry 16. The query may be in a Boolean format if supported by the document registry 16. For example, the query may be for a clinical document associated with a particular patient, and from a particular physician.

However, as stated above, the response to the query may not contain the desired clinical document themselves as the document registry 16 does not store the clinical documents according to this embodiment. The response may contain metadata associated with the desired clinical documents. The metadata may contain the location of the desired clinical documents in one or more datacenters. In the embodiment as shown, the desired clinical documents are located in the second datacenter 15.

To retrieve the desired clinical documents, the document consumer 18 may send a retrieve request to the second datacenter 15. The second datacenter 15 may respond by returning the desired clinical documents from its memory.

The first datacenter 14 and the second datacenter 15 are in data communication with each other but each datacenter is independent. Each datacenter manages and organizes the clinical documents within the datacenter without knowing how other datacenters are managing and organizing the clinical documents in their datacenters. The only information shared between the datacenters is the one or more update messages received from the source system 12 and the one or more patient manifests generated by the first datacenter 14 as described below.

If a patient manifest is generated by the first datacenter 14, then the first datacenter 14 will transmit the patient manifest to the document registry 16 to register the patient manifest. Also, the first datacenter 14 may transmit a copy of the patient manifest to second datacenter 15 to be stored in second datacenter 15.

As stated above, the first datacenter 14 may forward the received update message to the second datacenter 15. However, since both the first datacenter 14 and the second datacenter 15 receive update messages, it is possible that each datacenter will generate a patient manifest. This may result in redundant generation of patient manifests and registration of the redundant patient manifests in the document registry 16. This is undesirable because redundant generation of patient manifest unnecessarily consume processing power of the generating datacenter and registration of redundant manifests at the document registry 16 may negatively impact performance of the document registry 16. To prevent generation of redundant patient manifests and subsequent redundant registration, the processor in each first datacenter 14 and second datacenter 15 is programmed to determine whether to generate a patient manifest based on predetermined criteria such that only one manifest reflective the of the changes is generated between the two datacenters.

Predetermined criteria comprise information about the received update message. In particular, it includes the information about whether the update message includes the at least one new clinical document and/or metadata to be added to the datacenter, or instructions to delete at least one existing clinical document from the datacenter. The predetermined criteria also include the source of the update message, namely whether the update message is received from another datacenter or the update message is received from the source system. Predetermined criteria also includes whether the at least one clinical document to be added is associated with at least one existing manifest. The predetermined criteria also include information about whether that datacenter had previously generated the existing manifest associated with the clinical document to be deleted and/or added.

The processor in each first datacenter 14 and second datacenter 15, in some embodiments, may be programmed to perform steps 72-96 of method 70 to determine whether to generate an additional manifest if the update message comprising the at least one new clinical document to be added.

Each of the processor in each first datacenter 14 and second datacenter 15 is programmed to generate a new manifest if there is no existing manifest for that document, and the source of the document is the source system 12. The clinical document will have an existing manifest if that clinical document is associated with a patient for whom a manifest has been previously generated. For example, the clinical document to be stored in the datacenter may be associated with a patient who already has other clinical documents stored in the datacenter. In that circumstance, there will be an existing patient manifest reflecting the other clinical documents. Since there is no existing manifest for the document, the document is new to the system. In this case the datacenter is the first datacenter to receive the document and it is responsible for creating a manifest for that new document.

Each of the processor in the first datacenter 14 and second datacenter 15 is programmed not to generate an additional manifest if the there is no existing manifest for that document, and the source of the document is another datacenter. That is, the document is a replica, as it is not received from the source system 12 but another datacenter. In that case, it is not necessary to generate a manifest because the manifest will be generated by the datacenter, which first received the document.

Each of the processor in the first datacenter 14 and second datacenter 15 is programmed not to generate an additional manifest if the there is an existing manifest associated with that document, and that datacenter has not previously generated the existing manifest associated with that document. In this case, the datacenter will defer to the datacenter that has previously generated a manifest associated with that document to generate the manifest for that document.

Each of the processor in the first datacenter 14 and second datacenter 15 is programmed to generate an additional manifest if the there is an existing manifest associated with that document, and that datacenter has previously generated the existing manifest associated with that document. The datacenter may also determine whether there is a manifest pending for generation. If there is a manifest pending generation the datacenter will wait for the manifest to generate. Whether there is a manifest pending for generation is determined heuristically from system factors. For example, there might be a job pending in the processor of the datacenter to create a patient manifest for the same study from a previously received update message. Then, it would be redundant to start another job to create another patient manifest since the processor will refer to the latest information available about the manifest at the time the job is executed to generate a patient manifest. In other words, when the pending job generated by an earlier update message to create a patient manifest is executed, it will also take into account the clinical document that is included in more recently received update messages. It is not necessary to schedule another job to create a new patient manifest. In such a case, the processor will wait for the manifest to generate from the previous request. The processor is further programmed to generate a replacement manifest if there is an active manifest for the document. However, there isn't an active manifest for the document, the processor will generate a new manifest containing information about the added document.

As stated herein above, when the at least one update message comprises instructions to delete the at least one clinical document, each datacenter will delete that clinical document. In some embodiments, the clinical documents may not be physically deleted from the memory but deprecated. For example, a deleted document may be marked as “end-of-life” and no longer maintained. As such, the document is available for document archival purposes. That datacenter will then determine whether to generate a replacement manifest or a placeholder based on predetermined criteria.

The processor in each of the first datacenter 14 and the second datacenter 15 is programmed to generate a replacement manifest/placeholder when the at least one update message comprises instructions to delete the at least one existing manifest and that datacenter has previously generated the existing manifest associated with that clinical document.

If that datacenter is the datacenter that generated the existing manifest, the datacenter will determine whether to generate a placeholder or a replacement manifest. If all clinical documents associated with a patient manifest are deleted (a full delete), then a placeholder is generated. For example, if there is only one clinical document listed in a patient manifest and the update message comprises instructions to delete the sole clinical document, then a placeholder stating that there are no clinical documents associated with the patient is generated. This placeholder could also be a text file or a PDF format file stating that clinical documents associated with the patient have been deleted. If there is at least one clinical document associated with a patient remaining (a partial delete), then a replacement manifest is generated.

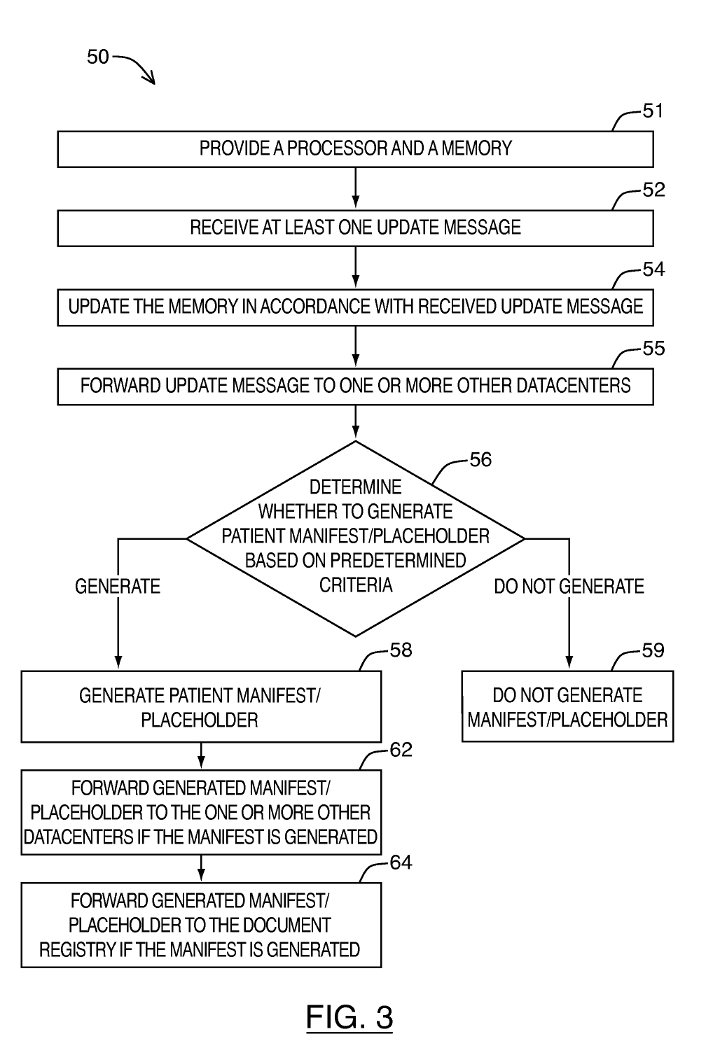

Referring now to FIG. 3, illustrated therein is a computer-implemented method 50 for managing clinical documents and patient manifests using a processor and a memory operatively coupled thereto at a datacenter according to another embodiment of the invention. The method maybe implemented by the first datacenter 14 and the second datacenter 15 described herein above.

At step 51, method 50 provides a processor and a memory operatively coupled thereto. The processor is used to perform at least one of the other steps in the method 50. The memory may store clinical documents and/or patient manifests. The memory may also store instructions to program the computer to perform at least some of the steps in method 50.

At step 52 the datacenter receives at least one update message. The at least one update message comprises a new clinical document to be added and/or instructions to delete at least one existing clinical document. The update message may be received from another datacenter or a source system. The source system may be a combination of hardware and software components similar to the source system 12 as described hereinabove. The clinical document to be added and/or the clinical document to be deleted may be similar to a clinical document propagated by the source system 12 as described hereinabove.

In step 54, the memory coupled to the processor is updated in accordance with the contents of the at least one update message. If the at least one update message comprises the at least one new clinical document, then that clinical document is stored in the memory. If the at least one update message includes instructions to delete an existing clinical document, then that existing clinical document is deleted from the memory. After performing the update in step 54, the method 50 proceeds to step 55.

In step 55, the update message is forwarded on one or more other datacenters connected to the datacenter. To assist in determination of the source of the update message, the update message may be marked as “replica” by a datacenter that is forwarding the update message to another datacenter. It is also possible for the recipient datacenter to determine the source of the clinical document, for example, by analyzing the network address of the sender, such that it is not necessary for the sending datacenter to make the update message as “replica”. For example, the recipient data center may be configured to consider update messages received from certain network addresses associated with other datacenters as replica. Step 55 need not necessarily be performed in this sequence. It may be performed earlier or later, or even be omitted.

In step 56, the processor determines whether to generate at least one patient manifest indicative of the update performed at step 54 based on predetermined criteria. The patient manifest may be similar to the patient manifest 30a described herein above. Some of the steps of method 70 and/or method 100 as described herein below may be implemented at this step 56.

Predetermined criteria, as described herein above, comprise information about the received update message. It includes the type of the update message received at the datacenter, in particular, whether the update message comprises the at least one new clinical document to be added or instructions to delete the at least one existing clinical document from the datacenter.

The predetermined criteria include the source of the update message, namely whether the update message is received from another datacenter or the source system. Predetermined criteria also include whether the clinical document to be added is associated with at least one existing manifest.

The predetermined criteria also include whether that datacenter had previously generated the existing manifest associated with the clinical document to be deleted and/or added.

Method 50 will indicate to generate a patient manifest at step 56 if the at least one update message comprises the at least one new clinical document to be added, the document has no existing manifest associated with it, and the document is received from a source system.

Method 50 will indicate not to generate an additional manifest at step 56 if the at least one update message comprises the at least one new clinical document to be added, the document has no existing manifest associated with it, and the document is received from another datacenter.

Method 50 will indicate not to generate an additional manifest at step 56 if the at least one update message comprises the at least one new clinical document to be added, and the document has an existing manifest associated with it, and the datacenter performing the method 50 is not the datacenter that has previously generated the existing manifest associated with that document.

Method 50 will indicate to generate a patient manifest at step 56 if the at least one update message comprises the at least one new clinical document to be added, and the document has an existing manifest associated with it, and the datacenter performing the method 50 is the datacenter that has previously generated a manifest for that document.

Method 50 will indicate to generate a patient manifest/placeholder at step 56 if the update message comprises instructions to delete a clinical document from the datacenter, and that datacenter has previously generated an existing manifest associated with the clinical document that is being deleted. If all clinical documents associated with the patient are being deleted by the update, then step 56 indicates to generate a placeholder. As stated herein above, the placeholder manifest may state that the clinical documents associated with this patient have been deleted. If there are clinical documents associated with the patient remaining after the update, then step 56 indicates to generate a replacement patient manifest reflective of the remaining clinical documents.

If it is determined that patient manifest or a placeholder be generated in step 56, method 50 proceeds to step 58, whereby a patient manifest or a placeholder is generated accordingly. If step 56 indicates not to generate a patient manifest or a placeholder, the method 50 proceeds to step 59, whereby a patient manifest or a placeholder is not generated.

In step 62, the generated patient manifest or the placeholder is forwarded to one or more other datacenters in communication with the datacenter.

In step 64, the generated patient manifest or the placeholder is forwarded to at least one document registry in communication with the datacenter. The document registry may be similar to document registry 16 described herein above. By sending the generated manifest or the place holder to the document registry, the document registry is updated of the contents of the database.

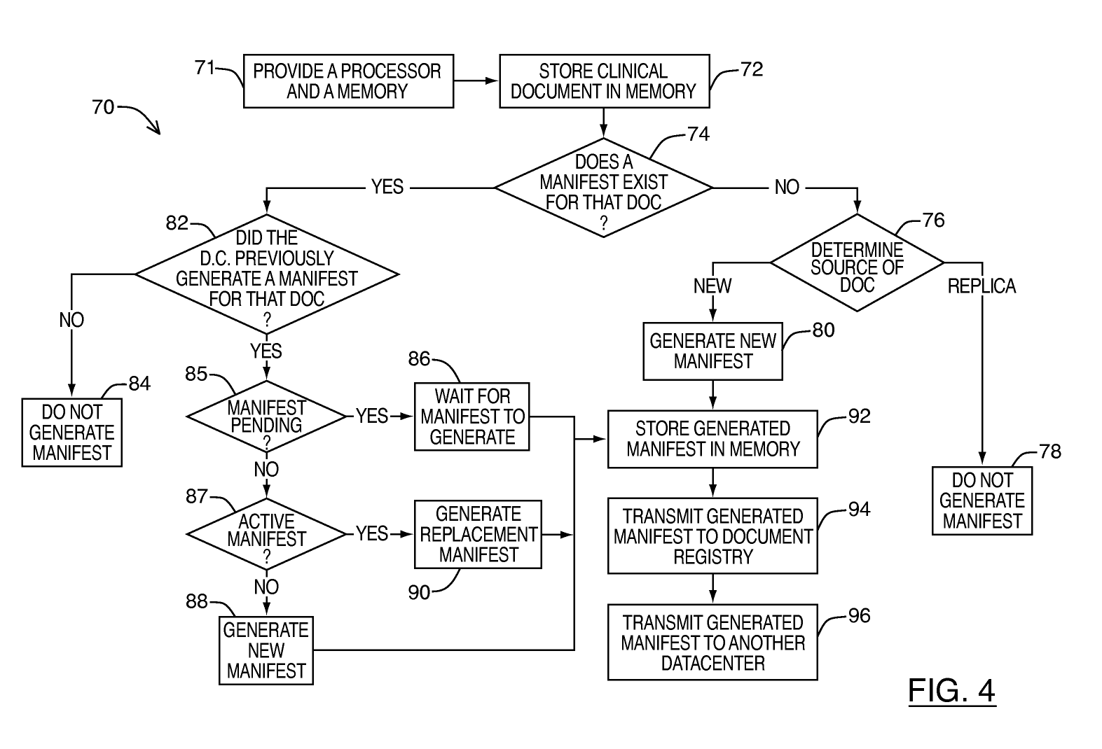

Referring now to FIG. 4, illustrated therein is a computer-implemented method 70 to determine whether a patient manifest should be generated when at least one update message comprising at least one new clinical document is received at a datacenter according to one embodiment of the invention.

Some of the steps of method 70 may be implemented at the first datacenter 14 or the second datacenter 15, or as part of method 50 as described herein above. Clinical documents and patient manifests in this embodiment may be similar to the clinical documents and the patient manifests as described in other embodiments of the invention herein above.

At step 71, method 70 provides a processor and a memory operatively coupled thereto. The processor is used to perform at least one of the other steps in the method 70. The memory may store clinical documents and/or patient manifests. The memory may also store instructions to program the computer to perform at least some of the steps in method 70.

At step 72, method 70 stores the at least one new clinical document in the memory. The at least one new clinical document may be received as an update message is described herein above. The update message may be received from another datacenter or a source system.

At step 74, method 70 determines whether the clinical document to be added is associated with an existing manifest. The clinical document will have an existing manifest if that clinical document is associated with a patient for whom a manifest has been previously generated. For example, the clinical document to be stored in the datacenter may be associated with a patient who already has other clinical documents stored in the datacenter. In that circumstance, there will be an existing patient manifest reflecting the other clinical document. If there is an existing manifest associated with the document, the method 70 proceeds to step 82. If there is no existing manifest associated with the document, the method 70 proceeds to step 76.

At step 76, method 70 determines whether the clinical document is received from a source system or another datacenter. The source system may be similar to the source system 12 as described hereinabove. If the at least one new clinical document is received from another datacenter, then method 70 proceeds to step 78 whereby a manifest is not generated.

If the at least one new clinical document is received from the source system, then processor generates a new manifest for the new clinical document at step 80.

At step 82, the processor determines whether the datacenter running the method 70 has generated a manifest for that clinical document. If the datacenter has not previously generated the existing manifest for that document, then the method 70 proceeds to step 84 whereby a manifest is not generated.

If the datacenter has previously generated the existing manifest for that document, the method 70 proceeds to step 85.

At step 85, the processor determines whether there is a manifest pending to be generated for that clinical document. Whether or not there is a manifest pending to be generated for the clinical document is determined heuristically from system factors as described herein above. If it is determined that there is a manifest pending to be generated, then method 70 proceeds to step 86 whereby the method waits 70 waits for the manifest to be generated. If there is not a manifest pending to be generated associated with that new clinical document, then the method 70 proceeds to step 87.

At step 87, the processor determines where there is at least one active manifest for a patient associated with the at least one new clinical document. If it is determined that there is at least one existing manifest in step 87, the method 70 proceeds to step 90 whereby a replacement manifest is generated. If there are no existing manifests for associated with that clinical document, then method 70 proceeds to step 88 whereby a new manifest is generated.

At step 86, it is determined whether the clinical document received is for a new manifest. That is, there had never been a patient manifest created for the patient associated with the clinical document that had been added. If the clinical document is for a new manifest then, method 70 proceeds to step 88 whereby a new manifest is generated. If the clinical document is not for a new manifest, the method 70 proceeds to step 90.

If a replacement manifest is created at step 90 or a new manifest is generated at steps 80 or 88, the method 70 proceeds to steps 92, 94, and 96.

At step 92, the generated manifest is stored in the memory of that datacenter. At step 94, the generated manifest is transmitted to a document registry. The document registry may be similar to the document registry 16 described herein above. By transmitting the manifest to the documents registry, the document registry may be informed of the clinical document being stored in the datacenter.

At step 96, the created manifest is transmitted to one or more other datacenters connected to this datacenter. This step may be omitted if there isn't any other datacenters connected to this datacenter. This step may also be omitted in some embodiments.

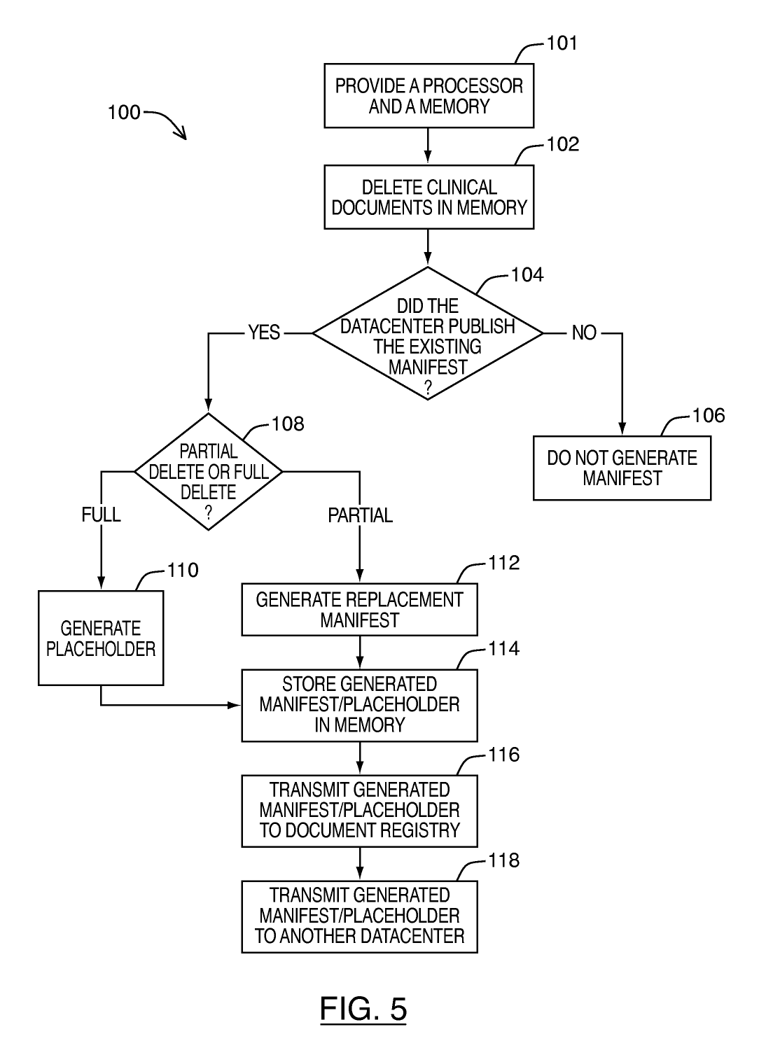

Referring now to FIG. 5, illustrated therein is a computer-implemented method 100 to determine whether a replacement patient manifest or a placeholder should be generated when at least one update message comprising instructions to delete at least one existing clinical document is received at a datacenter according to another aspect of the invention. The method 100 may be implemented in the first datacenter 14 and/or the second datacenter 15. The clinical document may be similar to a clinical document propagated by the source system 12 as described hereinabove. A patient manifest and a placeholder according to this embodiment of the invention may be similar to the patient manifest and placeholder as described hereinabove.

At step 101, method 100 provides a processor and a memory operatively coupled thereto. The processor is used to perform at least one of the other steps in the method 100. The memory may store clinical documents and/or patient manifests.

At step 102, method 102 deletes at least one existing clinical document from the memory of the datacenter. Method 100 then proceeds to step 104.

At step 104, method 100 determines whether this datacenter published an existing manifest associated with the deleted at least one clinical documents. If the datacenter did not generate the existing manifest, then the method 100 proceeds to step 106 whereby a manifest is not generated. Alternatively, if the existing manifest has been generated by the datacenter, then method 100 proceeds to step 108.

At step 108, the processor determines whether the clinical documents that were deleted were all the clinical documents associated with a particular manifest. If the clinical documents deleted were all the clinical documents referenced by a particular manifest, then the delete is considered to be a full delete, and the method 100 proceeds to step 110. Alternatively, if the clinical documents deleted were not all of the clinical documents referenced by a particular manifest, then the delete is considered to be a partial delete and method 100 proceeds to step 112.

At step 110, a placeholder indicative of the full delete is generated. The placeholder may be similar to the placeholders described hereinabove in other embodiments of the invention.

At step 112, a replacement manifest is generated.

After generating the replacement manifest at step 112, or the placeholder at step 110, the method 100 proceeds to steps 114, 116, and 118. At step 114, the generated manifest is stored in the memory.

At step 116, the generated manifest or the placeholder is transmitted to a remote document registry. The document registry may be similar to the document registry 16 as described hereinabove. By transmitting the manifest to the documents registry, the document registry may be informed of the clinical document being stored in the datacenter.

At step 118, the generated manifest or the placeholder is transmitted to one or more other datacenters connected to the datacenter. This step may be omitted if there isn't any other datacenters connected to this datacenter. This step may also be omitted in some embodiments.

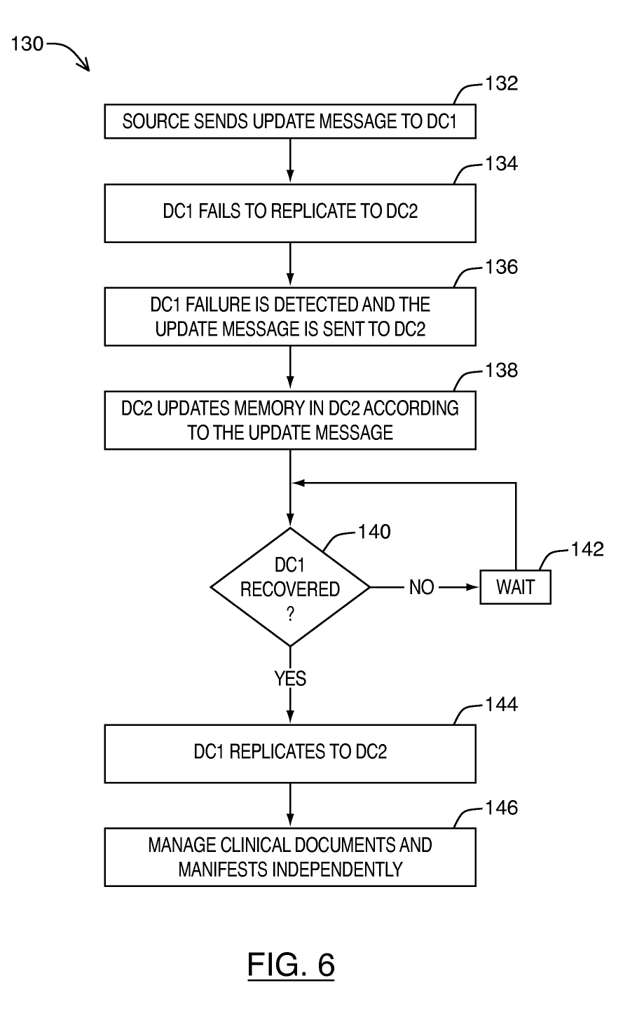

Referring now to FIG. 6, illustrated therein is a computer-implemented method 130 for managing clinical documents and patient manifests in the event of a failure of a datacenter according to one embodiment of the invention. The datacenters may be similar to the first datacenter 14 and the second datacenter 15 described hereinabove.

The method 130 begins at step 132 where at least one update message is received at the first datacenter (“DC1”). The at least one update message may be similar to the update messages in other embodiments of the invention described hereinabove. A source system similar to the source system 12 described hereinabove may be used to send the at least one update message to the datacenter.

At step 134, the first datacenter will update its memory in accordance with the update message received from the source system. The first datacenter may perform at least one of method 50, method 70, or method 100 as described hereinabove to determine whether a patient manifest should be generated. If a patient manifest is generated, the first datacenter will transmit the patient manifest to the document registry. However, the first datacenter fails to replicate and retransmit the update message and the generated manifest to a second datacenter (“DC2”).

At step 136, the failure of the first datacenter is detected, and the update message is sent to the second datacenter. The failure of the first datacenter may be detected in different ways. For example, the failure may be detected by the source system. In another example, the detection of the failure may be transparent to the source system. That is, the failure is detected at the network level (e.g. load balancer, DNS) and the update message is redirected without the knowledge of the source system.

The second datacenter will receive the at least one update message directly from the source system.

In step 138, the second datacenter will update its memory in accordance with the update message received from the source system. The second datacenter may perform at least one of method 50, method 70, or method 100 as described hereinabove to determine whether a patient manifest should be generated. If a patient manifest is generated, the second datacenter will transmit the patient manifest to the document registry. It will also replicate and retransmit the update message and the generated manifest to the first datacenter.

At step 140, method 130 will determine whether the first datacenter has recovered. If the first datacenter has not recovered, method 130 will wait for a period of time at step 142 before proceeding again to step 140. Alternatively, if the first datacenter has recovered, method 130 will then proceed to step 144.

At step 144, the first datacenter, which is now recovered, will replicate and retransmit the update message and the patient manifest to the second datacenter.

At step 146, each datacenter manages the manifests independently on a going forward basis.

While the steps of the above methods 50, 70, 100, and 130 have been described sequentially herein above, it should be noted that sequential performance of the steps may not need to occur for successful implementation of the method. As will be evident to one skilled in the art, rearranging the order of performance of the steps, or performing the steps in parallel, or omitting performance of some steps may be possible without abandoning the essence of the invention.

While certain features of the invention has been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A computer implemented method for managing clinical documents and patient manifests at a datacenter comprising:
a) providing a processor and a memory operatively coupled thereto;
b) receiving at least one update message at the processor, the at least one update message comprising at least one of: at least one new clinical document to be added to the memory, and instructions to delete at least one existing clinical document from the memory;
c) updating the memory in accordance with the update message;
d) determining whether to generate at least one new patient manifest based on predetermined criteria, the at least one patient manifest being indicative of the update performed; and
e) generating the at least one patient manifest wherein when the processor determines that the at least one patient manifest should be generated.

2. The method of claim 1, wherein when the at least one update message comprises the at least one new clinical document, the predetermined criteria comprises at least one of information about the source of the at least one update message, and whether the new clinical document to be added has associated with it at least one existing manifest, and whether the datacenter has previously generated the at least one existing manifest for that document.

3. The method of claim 2, wherein the at least one new patient manifest is not generated when at least one of the following predetermined criteria is met:
a) the at least one new clinical document is associated with the at least one existing manifest, and the at least one new clinical document is received from another datacenter; and
b) the at least one new clinical document is not associated with the at least one existing manifest, and the datacenter is not a datacenter that has previously generated the at least one existing manifest for that document.

4. The method of claim 2, wherein the at least one patient manifest is generated when at least one of the following predetermined criteria is met:
a) the at least one new clinical document is associated with the at least one existing manifest and the datacenter is a datacenter that has previously generated the at least one existing manifest for that document; and
b) the at least one new clinical document is not associated with an existing manifest, and the clinical document is received from a source system.

5. The method of claim 1, wherein when the at least one update message comprises instructions to delete the at least one existing clinical document, the predetermined criteria comprises whether that datacenter has previously generated at least one previous patient manifest for the at least one existing clinical document.

6. The method of claim 5, wherein the at least one patient manifest is generated when the datacenter has previously generated the at least one existing manifest for the at least one existing clinical document.

7. The method of claim 1 further comprising transmitting the at least one update message to at least one other datacenter.

8. The method of claim 7, wherein when the at least one datacenter fails before transmitting the at least one update message, the at least one source system detects the failure at that datacenter, and sends that update message to at least one other datacenter, and the processor in that datacenter and the datacenter that failed manages at least one manifest associated with the at least one update message independently.

9. The method of claim 1, wherein the format of the at least one patient manifest is compatible with cross-platform document sharing (XDS) standard.

10. A system for managing clinical documents and patient manifests at a datacenter comprising:
a) at least one datacenter having a processor and a memory operatively coupled thereto; and
b) at least one source system in data communication with the at least one datacenter, the source system configured to generate at least one update message comprising at least one new clinical document to be added to the memory of that datacenter, or instructions to delete at least one existing clinical document from the memory of that datacenter, and sending the at least one update message to that datacenter;
wherein the processor in each datacenter is programmed for:
i) receiving the at least one update message;
ii) updating the memory of that datacenter in accordance with the update message;
iii) determining whether to generate at least one new patient manifest based on predetermined criteria, the at least one patient manifest indicative of the update performed;
iv) generating the at least one patient manifest wherein when the processor determines that the new patient manifest should be generated.
The system of claim 10, wherein when the at least one update message comprises the at least one new clinical document, the predetermined criteria comprises at least one of information about the source of the at least one update message, and whether the new clinical document to be added is associated with at least one existing manifest, and whether the datacenter has previously generated the at least one existing manifest for that document.

11. The system of claim 10, wherein the processor in the at least one datacenter is further programmed not to generate the new patient manifest when at least one of the following predetermined criteria is met:
a) the at least one new clinical document is associated with the at least one existing manifest, and the at least one new clinical document is received from another datacenter; and
b) the at least one new clinical document is not associated with the at least one existing manifest, and the datacenter is not a datacenter that has previously generated the at least one existing manifest for that document.

12. The system of claim 11, wherein the processor in the at least one datacenter is further programmed to generate the new patient manifest at least one of the following predetermined criteria is met:
a) the at least one new clinical document is associated with the at least one existing manifest and the datacenter is a datacenter that has previously generated the at least one existing manifest for that document; and
b) the at least one new clinical document is not associated with an existing manifest, and the clinical document is received from a source system.

13. The system of claim 10, wherein when the at least one update message comprises instructions to delete the at least one existing clinical document, the predetermined criteria comprises whether that datacenter has previously generated at least one previous patient manifest for the at least one existing clinical document.

14. The system of claim 13, wherein the new patient manifest is generated when that datacenter has previously generated the at least one existing manifest for the at least one existing clinical document.

15. The system of claim 10, wherein the format of the at least one patient manifest is compatible with cross-platform document sharing (XDS) standard.

16. The system of claim 10, wherein the processor is further programmed for transmitting at least one update message to at least one other datacenter.

17. The system of claim 16, wherein when the at least one datacenter fails before transmitting the at least one update message, the at least one source system is further configured to detect the failure at that datacenter, and send that update message to at least one other datacenter, and the processor in that datacenter and the datacenter that failed is further programmed to manage at least one manifest associated with the at least one update message independently.

18. A datacenter comprising a memory and a processor operatively coupled to the memory wherein the processor is programmed for:
a) receiving at least one update message at the processor, the at least one update message comprising at least one of: at least one new clinical document to be added to the memory, and instructions to delete at least one existing clinical document from the memory;
b) updating the memory in accordance with the update message;
c) determining whether to generate at least one new patient manifest based on predetermined criteria, the at least one patient manifest being indicative of the update performed; and
d) generating the at least one patient manifest wherein when the processor determines that the at least one patient manifest should be generated.

19. The datacenter of claim 18, wherein the predetermined criteria comprises at least one of information about the source of the update message, whether the clinical document to be added has associated with it an existing manifest, and whether the datacenter has previously generated a previous patient manifest associated with the update message.

20. The datacenter of claim 18, wherein the format of each patient manifest is compatible with cross-platform document sharing (XDS) protocol.
